(19) United States
(12) Patent Application Publication
(10) Pub. No.: US 2012/0141968 A1
(43) Pub. Date: Jun. 7, 2012

(54) Evaluation Assistant for Online Discussion

(75) Inventors: Na Li, Beijing (CN); Kai Yan Yang, Beijing (CN); Fanguang Kong, Beijing (CN); Yong Rui, Sammamish, WA (US)

(73) Assignee: Microsoft Corporation, Redmond, WA (US)

(21) Appl. No.: 12/961,533

(22) Filed: Dec. 7, 2010

(51) Int. Cl. G09B 3/00

(52) U.S. Cl. 434/350

(57) ABSTRACT

Discussion evaluation may be provided. First, an assignment page including an evaluation link may be displayed and a user initiated input corresponding to the evaluation link may be received. Next, an evaluation view may be displayed in response to the received user initiated input. The displayed evaluation view may comprise an evaluation assistant data section and a raw discussion data section. Evaluation data may then be received in response to the displayed evaluation view.

### BACKGROUND

A healthy amount of communication is a helpful stimulant for distance learning because this not only brings people closer together, but prompts deeper reflection and re-examination of existing solutions. Today, some infrastructure to support online discussion is in place in distance learning systems (e.g. message boards and discussion boards). However, educators expect to further monitor and measure the efficiency of student discussions more easily.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Discussion evaluation may be provided. First, an assignment page including an evaluation link may be displayed and a user initiated input corresponding to the evaluation link may be received. Next, an evaluation view may be displayed in response to the received user initiated input. The displayed evaluation view may comprise an evaluation assistant data section and a raw discussion data section. Evaluation data may then be received in response to the displayed evaluation view.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1A is a block diagram of a discussion system;

FIG. 1B is a block diagram of a discussion system;

FIG. 2 is a flow chart of a method for providing discussion evaluation;

FIG. 3 is a screen shot illustrating an assignment page;

FIG. 4 is a screen shot illustrating an assignment page;

FIG. 5 is a screen shot illustrating an evaluation view;

FIG. 6 is a screen shot illustrating an evaluation view;

FIG. 7 is a screen shot illustrating an evaluation view;

FIG. 8 is a screen shot illustrating an evaluation view;

FIG. 9 is a screen shot illustrating an evaluation view; and

FIG. 10 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Consistent with embodiments of the invention, a distance learning system may assist an educator in evaluating a students' performance in online discussions. Embodiments of the invention may include an evaluation view at a front end and an extensible evaluation engine at a backend. The evaluation view may allow the educator to grade the online discussion in an efficient way. The evaluation engine may include extensibility for third party evaluation modules to adapt to third party online discussion systems, for example.

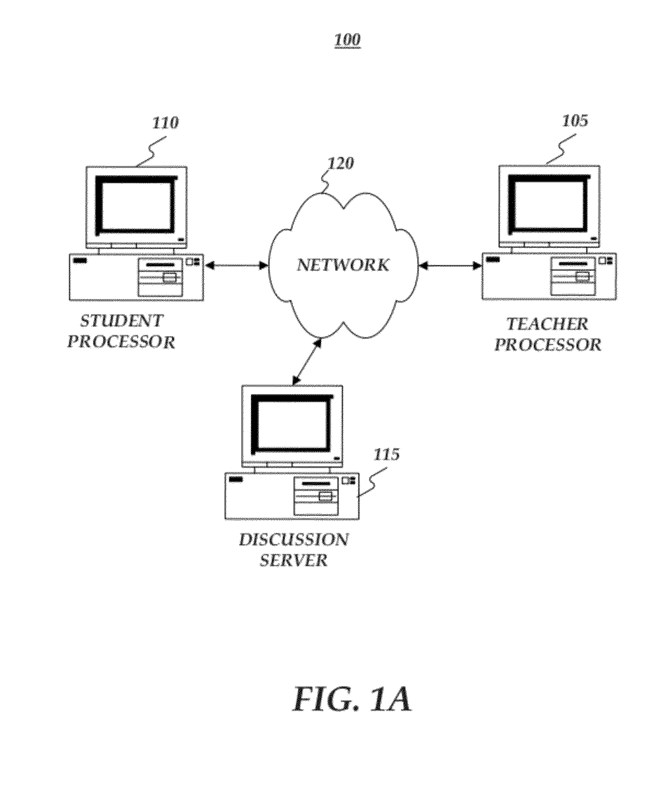

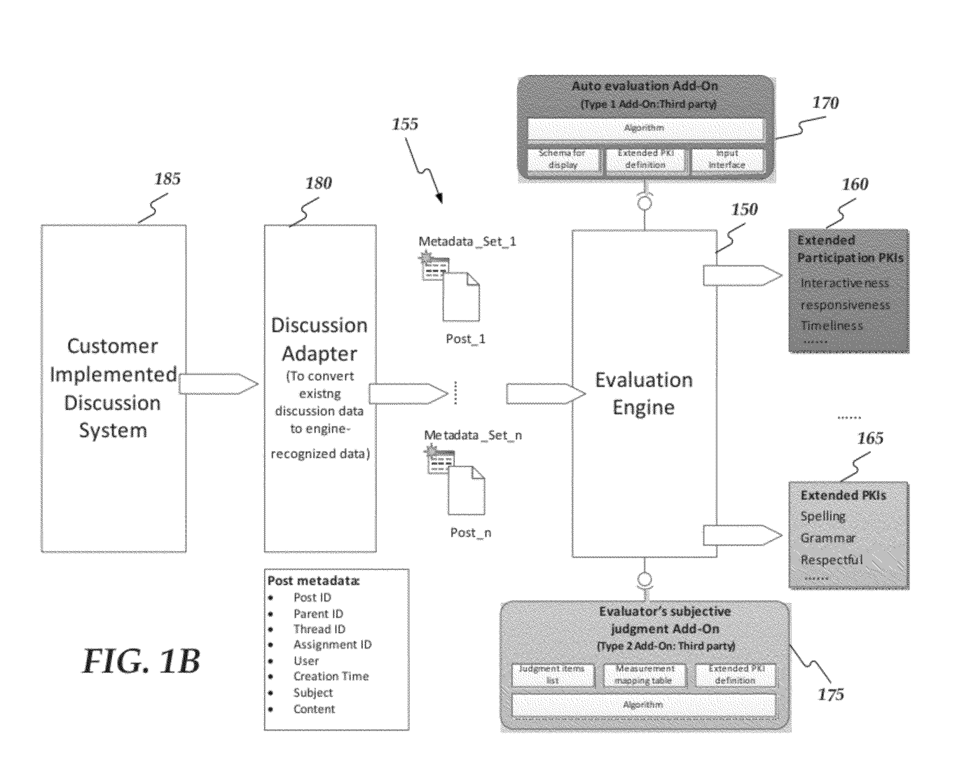

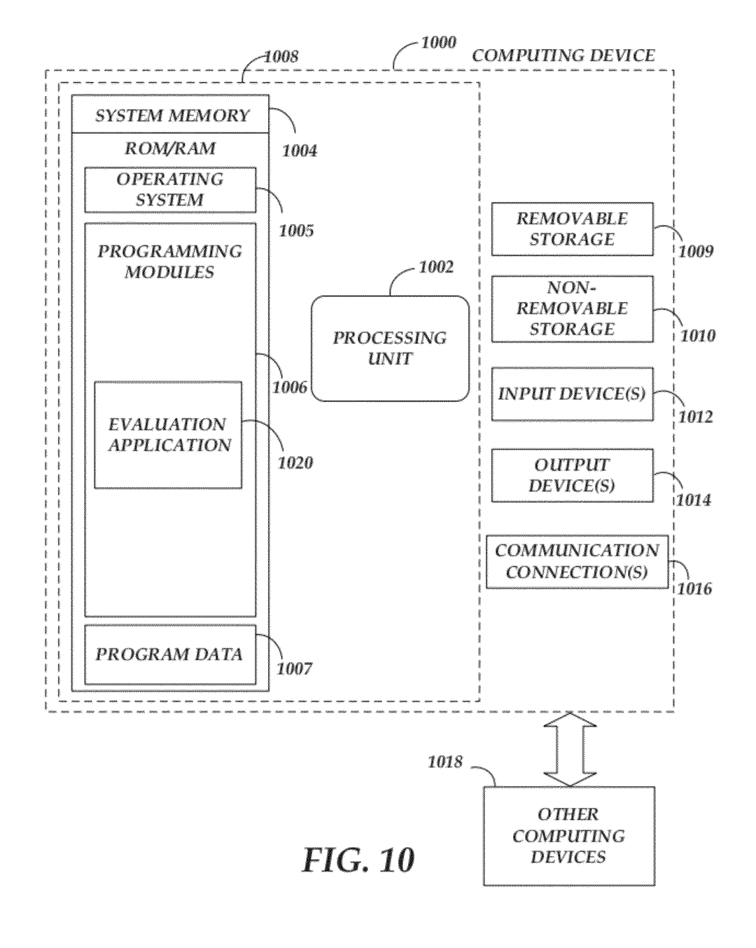

FIG. 1A shows a discussion system 100 comprising a teacher processor 105, a student processor 110, a discussion server 115, and a network 120. Any one of teacher processor 105, student processor 110, and discussion server 115 may comprise, but not limited to, a desktop computer, a notebook computer, a mobile device, a smart telephone, or a personal digital assistant, for example. Network 120 may comprise the internet or any type network over which teacher processor 105, student processor 110, and discussion server 115 may communicate. Any one of teacher processor 105, student processor 110, and discussion server 115 may be implemented using, for example, a computing device 1000 as described in greater detail below with respect to FIG. 10.

For an online discussion system, a teacher using teacher processor 105 may evaluate a student's (e.g. using student processor 110) discussion efficiency with respect to a discussion board running on discussion server 115. The evaluation may comprise, for example, how proactive the student is, how important the student's replys are, etc. Embodiment of the invention may include an evaluation view of an online discussion that can facilitate an assessment of a student's performance and save a teacher time in performing the assessment. The evaluation view may contain two parts: i) evaluation assistant data; and ii) raw discussion data. The evaluation assistant data may be flexible in that a third party may define both the calculation mechanism and the presentation method. Meanwhile, a user interface for obtaining the teacher's subjective judgment may be provided in the evaluation view. The evaluation view may provide the ability to generate a new dimension of evaluation assistant data by analyzing those subjective inputs in some way. Search function may also be provided in the evaluation view.

As shown in FIG. 1B, embodiment of the invention may also include an evaluation engine 150 that may run, for example, on discussion server 115. Evaluation engine 150 may take input data 155 (e.g. posts content and metadata) as input from student processor 110 and output statistical data defined by a first grouped key performance indicator 160 and a second grouped key performance indicator 165. First grouped key performance indicator 160 and second grouped key performance indicator 165 may be respectively extended through two types of add-on's added to evaluation engine 150: i) an auto evaluation add-On 170 and ii) an evaluator's subjective judgment add-on 175. First grouped key performance indicator 160 and second grouped key performance indicator 165 may be extended and displayed in an evaluation assistant data section 505 as described in detail below. Evaluation engine 150's data contract and architecture design may consider the common character of online discussion system requirements so that it can be adopted by conventional systems easily. For example, input data 155 may be received directly from student processor 110 or may be run through a discussion adapter 180 to place it in a proper format if input data 155 is received from a customer implemented discussion system 185.

Auto evaluation add-On 170 and evaluator's subjective judgment add-on 175 may be defined by a third party (e.g. a teacher.) Auto evaluation add-On 170 may provide objective evaluation of input data 155 in the form of first grouped key performance indicator 160. Evaluator's subjective judgment add-on 175 may provide subjective evaluation of input data 155 in the form of second grouped key performance indicator 165. Evaluator's subjective judgment add-on 175 may receive subjective inputs from the teacher in the form of the rubric as discussed in greater detail below.

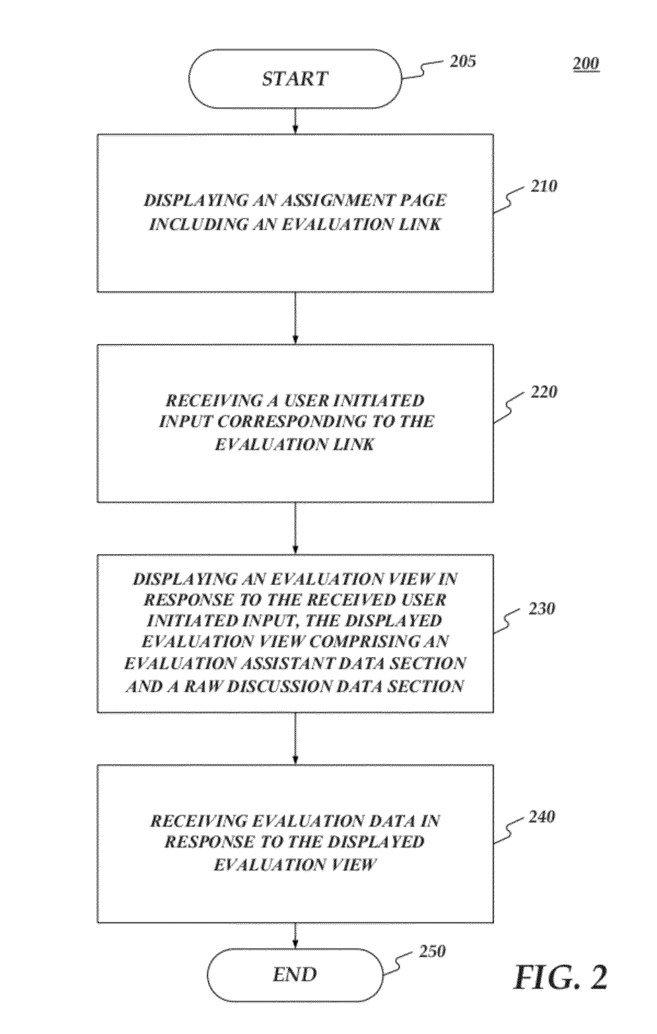

FIG. 2 is a flow chart setting forth the general stages involved in a method 200 consistent with an embodiment of the invention for providing discussion evaluation. Method 200 may be implemented using discussion server 115. Computing device 1000 as described in more detail below with respect to FIG. 10 may comprise an operating environment for discussion server 115. Ways to implement the stages of method 200 will be described in greater detail below.

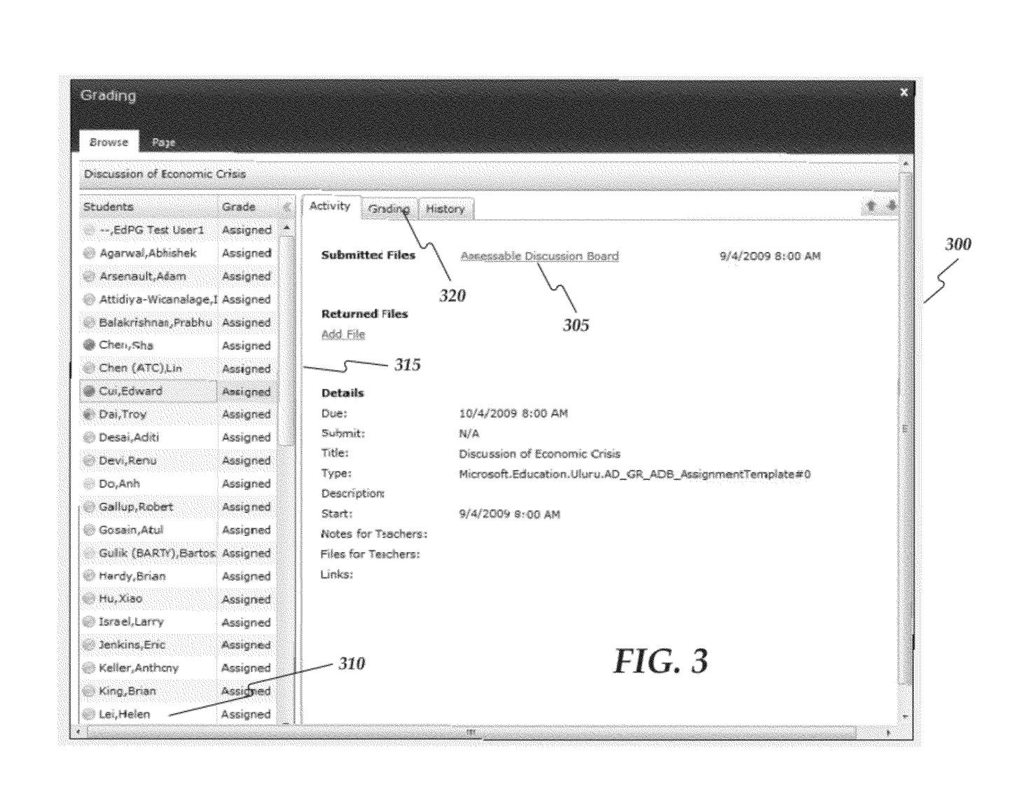

Method 200 may begin at starting block 205 and proceed to stage 210 where discussion server 115 may display an assignment page 300 including an evaluation link 305 to teacher processor 105 as shown in FIG. 3. For example, a teacher using teacher processor 105 may wish to evaluate a student's participation in a discussion board operating on discussion server 115. Consequently, the teacher may engage with assignment page 300.

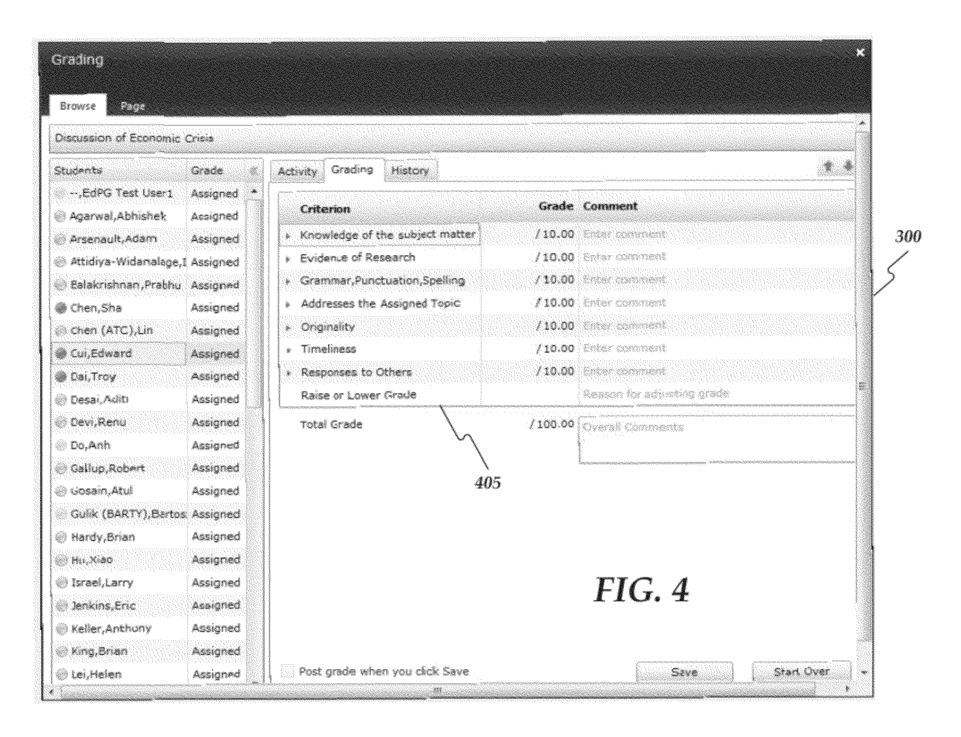

From stage 210, where discussion server 115 displays assignment page 300 including evaluation link 305, method 200 may advance to stage 220 where discussion server 115 may receive a user initiated input corresponding to evaluation link 305 from teacher server 105. For example, the teacher may select a student 310 from student name section 315 and click on evaluation link 305 in assignment page 300. As a result, discussion server 115 may navigate the teacher to the evaluation view as described in stage 230 below. Before navigating to the evaluation view, the teacher may click on a grading link 320. In response, discussion server 115 may display a grading view 405 on teacher server 105 for the selected student 310 as shown in FIG. 4. Grade view 405 may display a grade thus far that selected student 310 is receiving based on evaluations the teacher has already preformed on the student's participation in the discussion board running on discussion server 115.

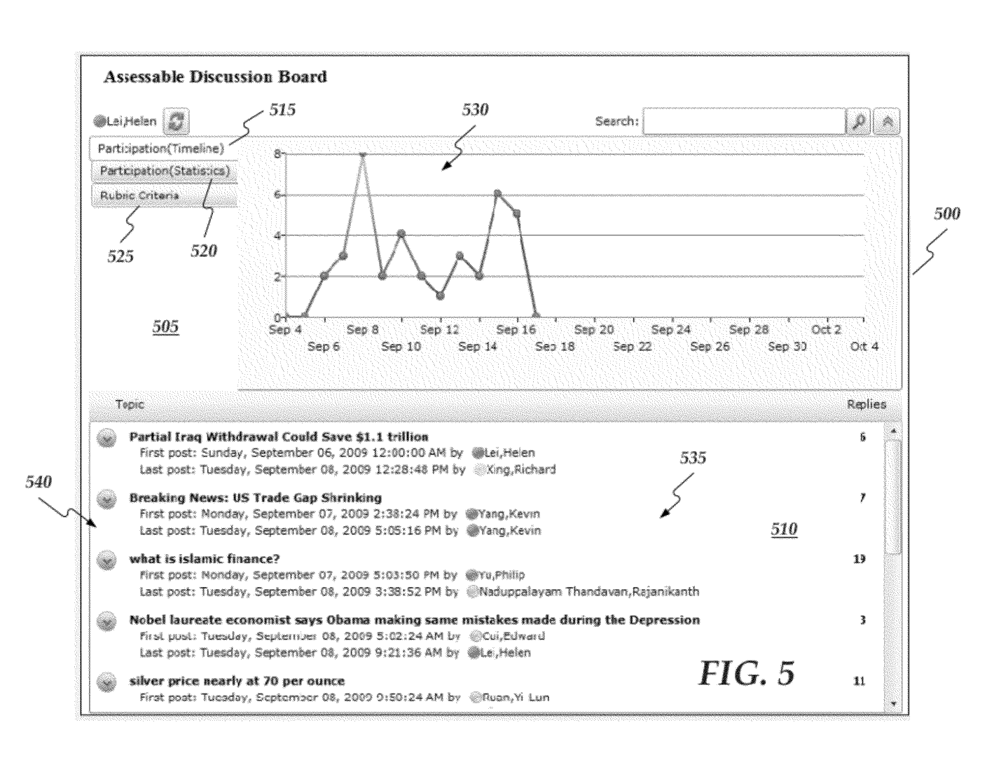

Once discussion server 115 receives the user initiated input corresponding to evaluation link 305 in stage 220, method 200 may continue to stage 230 where discussion server 115 may display an evaluation view 500 to teacher server 105 in response to the received user initiated input as shown in FIG. 5. Displayed evaluation view 500 may comprise evaluation assistant data section 505 (e.g. top) and a raw discussion data section 510 (e.g. bottom.) For example, evaluation assistant data section 505 may include a participation timeline link 515, a participation statistics link 520, and a rubric criteria link 525.

In response to receiving a selection of participation timeline link 515, a graphical representation 530 of a student's participation in a discussion board assignment may be displayed by discussion server 115 as shown in FIG. 5. Graphical representation 530 may indicate, for example, a number of posts the student made on a corresponding given day.

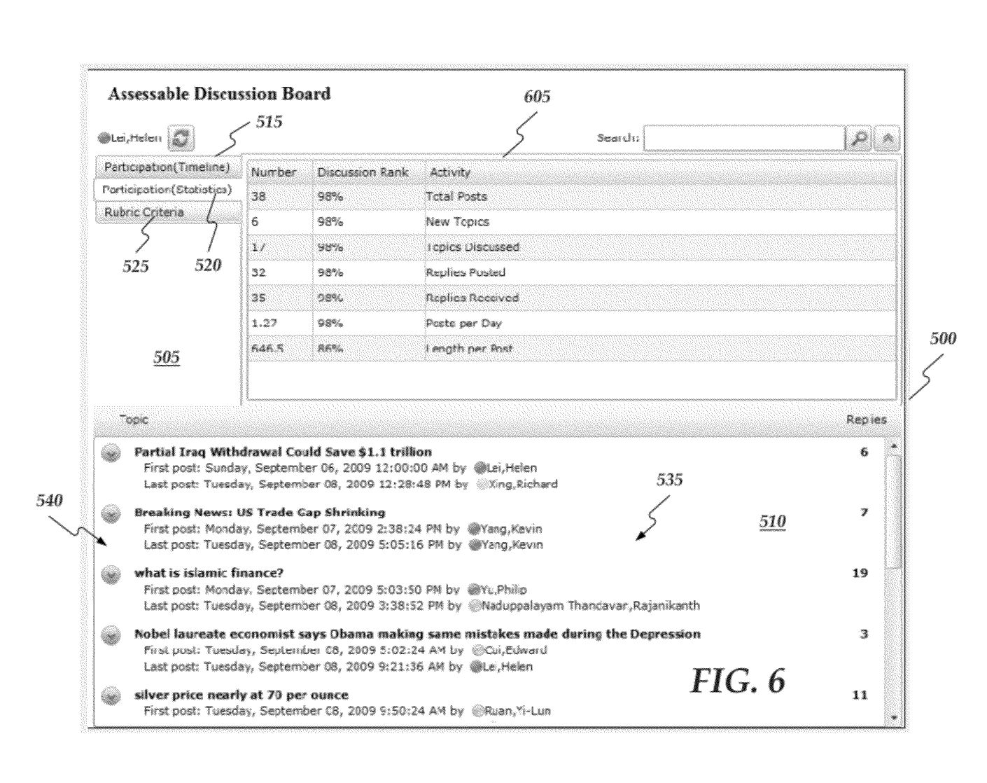

In response to receiving a selection of statistics link 520 from teacher processor 105, a participation table 605 summarizing a student's participation in a discussion board assignment may be displayed by discussion server 115 as shown in FIG. 6. Participation table 605 may include each of the following: a number of posts the student made, a number of new topics the student posted, a number of topics the student discussed, a number of replies the student made, an average number of posts the student made per day, and an average length of the student's posts.

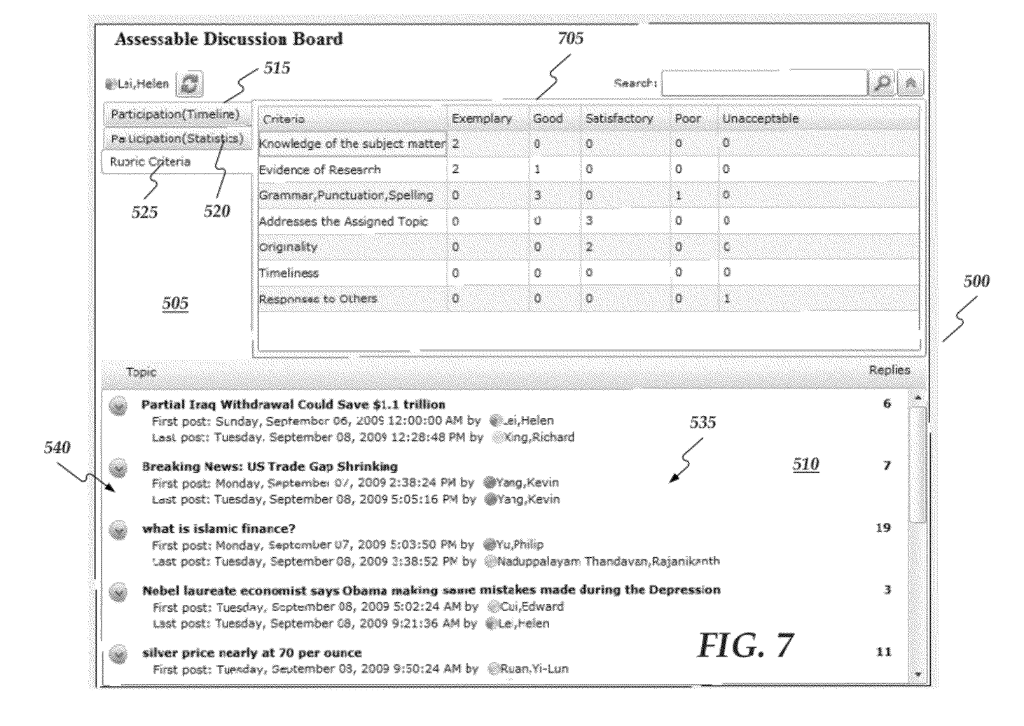

In response to receiving a selection of rubric criteria link 525 from teacher processor 105, a rubric table 705 summarizing a student's score in the discussion board assignment may be displayed by discussion server 115 as shown in FIG. 7. Rubric table 705 may indicate the student's score in each of the following rubric categories: knowledge of the subject matter, evidence of research, grammar, punctuation, spelling, addresses the topic, originality, and timeliness, and responses to others. As stated above, data defining a rubric corresponding to rubric table 705 may be dynamic and supplied by a third party.

As stated above, discussion server 115 may display evaluation view 500 to teacher server 105 in response to the received user initiated input. Displayed evaluation view 500 may comprise, in addition to evaluation assistant data section 505 (e.g. top), raw discussion data section 510 (e.g. bottom.) As shown in FIG. 5, raw discussion data section 510 may include a plurality of threads 535 a student participated in. In addition, raw discussion data section 510 may include a plurality of thread links 540, each respectively corresponding to plurality of threads 535. Plurality of threads 535 may comprise threads the student participated in by, for example, either adding to an existing post or creating a new post.

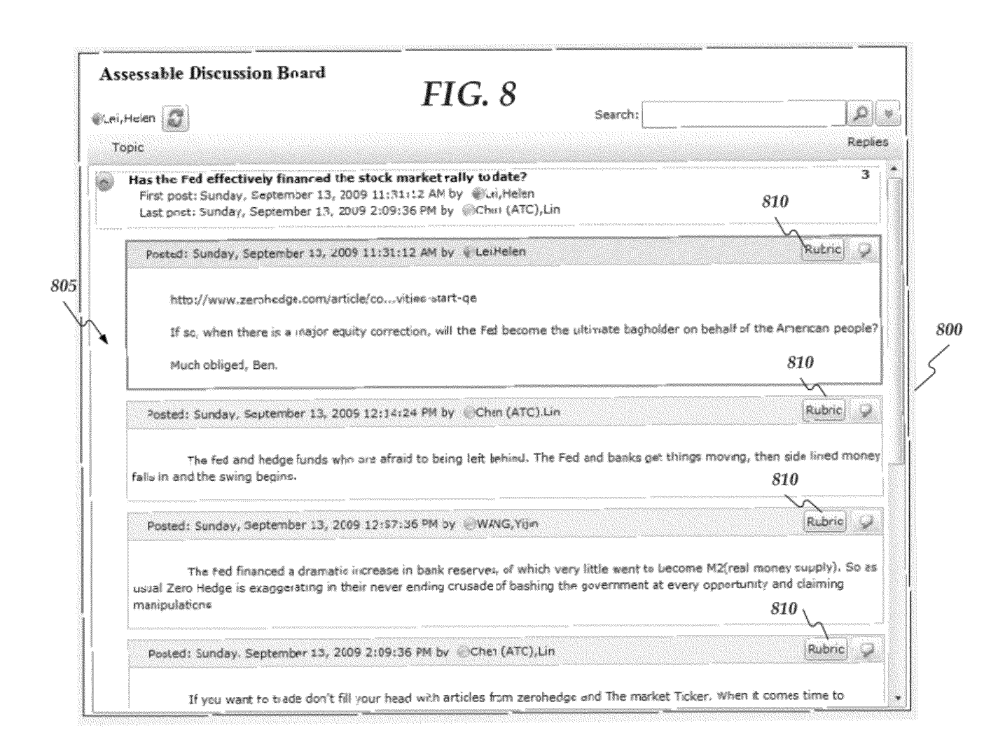

In response to receiving a selection of one of the plurality of thread links 540 from teacher processor 105, an expanded view 800 of a one of the plurality of threads 535 corresponding to the selected one of the plurality of thread links 540 may be displayed by discussion server 115 as shown in FIG. 8. Expanded view 800 may include a plurality of posts 805 corresponding to one of the plurality of threads 535 corresponding to the selected one of the plurality of thread links 540. Expanded view 800 may comprise a plurality of rubric links 810 respectively corresponding to the plurality of posts 805.

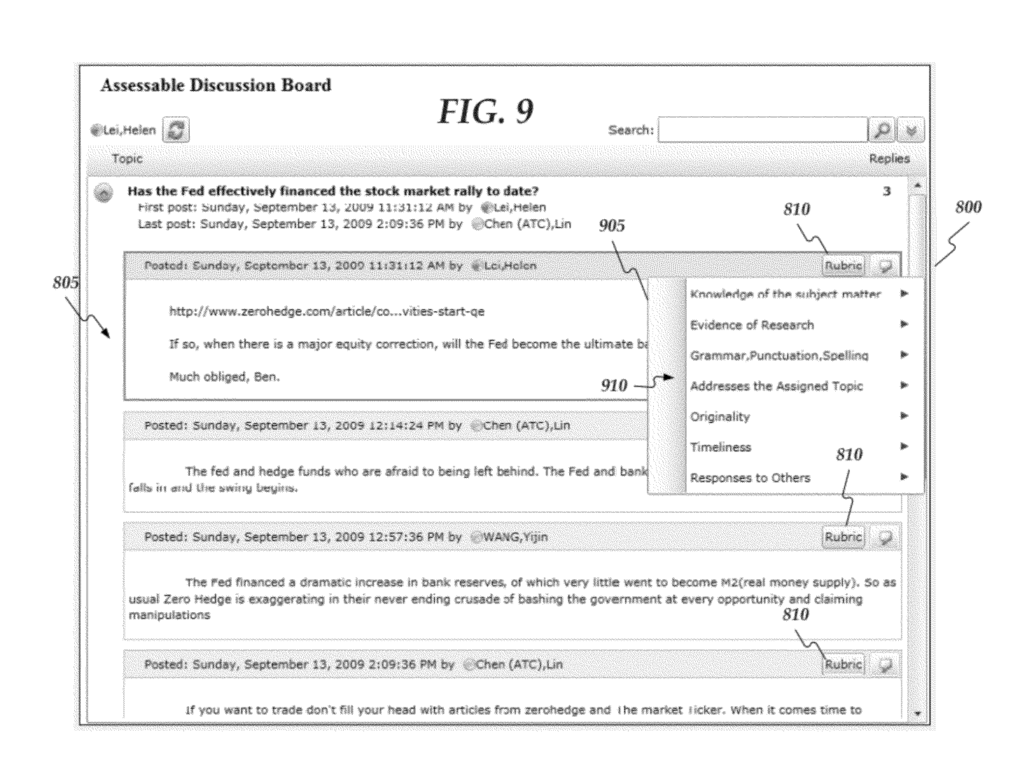

In response to receiving a selection of one of the plurality of rubric links 810 from teacher processor 105, a rubric menu 905 may be displayed in expanded view 800 by discussion server 115 as shown in FIG. 9. Rubric menu 905 may comprise a plurality of category links 910 corresponding to a plurality of rubric categories.

After discussion server 115 displays the evaluation view in stage 230, method 200 may proceed to stage 240 where discussion server 115 may receive evaluation data in response to the displayed evaluation view from teacher server 105. For example, in response to receiving a selection of one of the plurality of category links 910 from teacher processor 105, discussion server 115 may display a table configured to receive scores. Consequently, discussion server 115 may receive evaluation data comprises at least one score for one of the plurality of posts 805 corresponding to the selected of the one of plurality of rubric links 810. Once discussion server 115 receives the evaluation data in stage 240, method 200 may then end at stage 250.

An embodiment consistent with the invention may comprise a system for providing discussion evaluation. The system may comprise a memory storage and a processing unit coupled to the memory storage. The processing unit may be operative to display an assignment page including an evaluation link and receive a user initiated input corresponding to the evaluation link. In addition, the processing unit may be operative to display an evaluation view in response to the received user initiated input. The displayed evaluation view may comprise an evaluation assistant data section and a raw discussion data section. Moreover, the processing unit may be operative to receive evaluation data in response to the displayed evaluation view.

Another embodiment consistent with the invention may comprise a system for providing discussion evaluation. The system may comprise a memory storage and a processing unit coupled to the memory storage. The processing unit may be operative to displaying an evaluation view. The displayed evaluation view may comprise an evaluation assistant data section and a raw discussion data section. The evaluation assistant data section may include a participation timeline link, a participation statistics link, and a rubric criteria link. The raw discussion data section may include a plurality of threads a student participated in and a plurality of thread links each respectively corresponding to the plurality of threads. Moreover, the processing unit may be operative to receive evaluation data in response to the displayed evaluation view.

Yet another embodiment consistent with the invention may comprise a system for providing discussion evaluation. The system may comprise a memory storage and a processing unit coupled to the memory storage. The processing unit may be operative to display an assignment page including an evaluation link and to receive a user initiated input corresponding to the evaluation link. Furthermore, the processing unit may be operative to display an evaluation view in response to the received user initiated input. The displayed evaluation view may comprise an evaluation assistant data section and a raw discussion data section. The evaluation assistant data section may include a participation timeline link, a participation statistics link, and a rubric criteria link. The raw discussion data section may include a plurality of threads a student participated in and a plurality of thread links each respectively corresponding to the plurality of threads. Moreover, the processing unit may be operative to receive evaluation data in response to the displayed evaluation view.

FIG. 10 is a block diagram of a system including computing device 1000. Consistent with an embodiment of the invention, the aforementioned memory storage and processing unit may be implemented in a computing device, such as computing device 1000 of FIG. 10. Any suitable combination of hardware, software, or firmware may be used to implement the memory storage and processing unit. For example, the memory storage and processing unit may be implemented with computing device 1000 or any of other computing devices 1018, in combination with computing device 1000. The aforementioned system, device, and processors are examples and other systems, devices, and processors may comprise the aforementioned memory storage and processing unit, consistent with embodiments of the invention. Furthermore, computing device 1000 may comprise an operating environment for discussion server 115 as described above. Discussion server 115 may operate in other environments and is not limited to computing device 1000.

With reference to FIG. 10, a system consistent with an embodiment of the invention may include a computing device, such as computing device 1000. In a basic configuration, computing device 1000 may include at least one processing unit 1002 and a system memory 1004. Depending on the configuration and type of computing device, system memory 1004 may comprise, but is not limited to, volatile (e.g. random access memory (RAM)), non-volatile (e.g. read-only memory (ROM)), flash memory, or any combination. System memory 1004 may include operating system 1005, one or more programming modules 1006, and may include a program data 1007. Operating system 1005, for example, may be suitable for controlling computing device 1000's operation. In an embodiment, programming modules 1006 may include, for example, evaluation application 1020. Furthermore, embodiments of the invention may be practiced in conjunction with a graphics library, other operating systems, or any other application program and is not limited to any particular application or system. This basic configuration is illustrated in FIG. 10 by those components within a dashed line 1008.

Computing device 1000 may have additional features or functionality. For example, computing device 1000 may also include additional data storage devices (removable and/or non-removable) such as, for example, magnetic disks, optical disks, or tape. Such additional storage is illustrated in FIG. 10 by a removable storage 1009 and a non-removable storage 1010. Computing device 1000 may also contain a communication connection 1016 that may allow device 1000 to communicate with other computing devices 1018, such as over a network in a distributed computing environment, for example, an intranet or the Internet. Communication connection 1016 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 1004, removable storage 1009, and non-removable storage 1010 are all computer storage media examples (i.e. memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1000. Any such computer storage media may be part of device 1000. Computing device 1000 may also have input device(s) 1012 such as a keyboard, a mouse, a pen, a sound input device, a touch input device, etc. Output device(s) 1014 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 1004, including operating system 1005. While executing on processing unit 1002, programming modules 1006 (e.g. evaluation application 1020) may perform processes including, for example, one or more method 200's stages as described above. The aforementioned process is an example, and processing unit 1002 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing discussion evaluation, the method comprising:
displaying an assignment page including an evaluation link;
receiving a user initiated input corresponding to the evaluation link;
displaying an evaluation view in response to the received user initiated input, the displayed evaluation view comprising an evaluation assistant data section and a raw discussion data section; and
receiving evaluation data in response to the displayed evaluation view.

2. The method of claim 1, wherein displaying the assignment page comprises displaying the assignment page further including a student name section.

3. The method of claim 2, wherein receiving the user initiated input corresponding to the evaluation link comprises receiving the user initiated input further indicating a student from the student name section.

4. The method of claim 1, wherein displaying the evaluation view comprising the evaluation assistant data section comprises displaying the evaluation view comprising the evaluation assistant data section including a participation timeline link, a participation statistics link, and a rubric criteria link.

5. The method of claim 4, further comprising:
receiving a selection of the participation timeline link; and
displaying, in response to the received selection of the participation timeline link, a graphical representation of a student's participation in a discussion board assignment.

6. The method of claim 5, wherein displaying the graphical representation comprises displaying the graphical representation indicating a number of posts the student made on a corresponding given day.

7. The method of claim 4, further comprising:
receiving a selection of the participation statistics link; and
displaying, in response to the received selection of the participation statistics criteria link, a participation table summarizing a student's participation in a discussion board assignment.

8. The method of claim 7, wherein displaying the participation table comprises displaying the participation table including each of the following: a number of posts the student made, a number of new topics the student posted, a number of topics the student discussed, a number of replies the student made, an average number of posts the student made per day, and an average length of the student's posts.

9. The method of claim 4, further comprising:
receiving a selection of the rubric criteria link; and
displaying, in response to the received selection of the rubric criteria link, a rubric table summarizing a student's score in a discussion board assignment.

10. The method of claim 9, wherein displaying the rubric table comprises displaying the rubric table indicating the student's score in each of the following rubric categories: knowledge of the subject matter, evidence of research, grammar, punctuation, spelling, addresses the topic, originality, and timeliness, and responses to others.

11. The method of claim 9, further comprising receiving, from a third party, data defining a rubric corresponding to the rubric table.

12. The method of claim 1, wherein displaying the evaluation view comprising the raw discussion data section comprises displaying the evaluation view comprising the raw discussion data section including a plurality of threads a student participated in and a plurality of thread links each respectively corresponding to the plurality of threads.

13. The method of claim 12, wherein displaying the evaluation view comprising the raw discussion data section including the plurality of threads the student participated in comprises displaying the evaluation view comprising the raw discussion data section including the plurality of threads a student participated in by either adding to an existing post or creating a new post.

14. The method of claim 12, further comprising:
receiving a selection of a one of the plurality of thread links; and
displaying, in response to the selection of the one of the plurality of thread links, an expanded view of a one of the plurality of threads corresponding to the selected one of the plurality of thread links

15. The method of claim 14, wherein displaying the expanded view comprises displaying a plurality of posts corresponding to the one of the plurality of threads corresponding to the selected one of the plurality of thread links.

16. The method of claim 15, wherein displaying the plurality of posts comprises displaying a plurality of rubric links respectively corresponding to the plurality of posts.

17. The method of claim 16, further comprising:
receiving a selection of a one of the plurality of rubric links; and
displaying, in response to the selection of the one of the plurality of rubric links, a rubric menu comprising a plurality of category links corresponding to a plurality of rubric categories.

18. The method of claim 17, further comprising:
receiving a selection of a one of the plurality of category links; and
wherein receiving evaluation data comprises receiving a score for a one of the plurality of posts corresponding to the selected of the one of the plurality of rubric links.

19. A computer-readable medium that stores a set of instructions which when executed perform a method for providing discussion evaluation, the method executed by the set of instructions comprising:
displaying an evaluation view, the displayed evaluation view comprising an evaluation assistant data section and a raw discussion data section wherein displaying the evaluation view comprising the evaluation assistant data section comprises displaying the evaluation view comprising the evaluation assistant data section including a participation timeline link, a participation statistics link, and a rubric criteria link wherein displaying the evaluation view comprising the raw discussion data section comprises displaying the evaluation view comprising the raw discussion data section including a plurality of threads a student participated in and a plurality of thread links each respectively corresponding to the plurality of threads; and
receiving evaluation data in response to the displayed evaluation view.

20. A system for providing discussion evaluation, the system comprising:
a memory storage; and
a processing unit coupled to the memory storage, wherein the processing unit is operative to:
display an assignment page including an evaluation link;
receive a user initiated input corresponding to the evaluation link;
display an evaluation view in response to the received user initiated input, the displayed evaluation view comprising an evaluation assistant data section and a raw discussion data section wherein the evaluation assistant data section includes a participation timeline link, a participation statistics link, and a rubric criteria link and wherein the raw discussion data section includes a plurality of threads a student participated in and a plurality of thread links each respectively corresponding to the plurality of threads; and
receive evaluation data in response to the displayed evaluation view.
